(19) United States
(12) Patent Application Publication
(10) Pub. No.: US 2008/0157918 A1
(43) Pub. Date: Jul. 3, 2008

(54) SYSTEM FOR VALIDATING REFILLABLE FUEL CARTRIDGES

(75) Inventors: GREGORY R. BLACK, Vernon Hills, IL (US); JERALD A. HALLMARK, Gilbert, AZ (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/617,814

(22) Filed: Dec. 29, 2006

(51) Int. Cl. G05B 19/00

(52) U.S. Cl. 340/5.8

(57) ABSTRACT

A system for validating refillable fuel cartridges is provided. The system includes a first device (302) and a second device (304). The first device is a refillable fuel cartridge that can be used in an electronic device (100). The first device includes a first access controller (306), a first transceiver (308), and a first fuel container (312). The first access controller authenticates the second device by using a first pre-specified authentication technique. The first transceiver receives an authentication query from the second device and the first fuel container stores fuel. The second device includes a second access controller (316), a second transceiver (318), and a second fuel container (322). The second access controller authenticates the first device by using a second pre-specified authentication technique. The second transceiver receives an authentication query from the first device and the second fuel container stores fuel.

### FIELD OF THE INVENTION

The present invention relates in general to fuel cells, and more specifically, to a system for validating a refillable fuel cartridge that can be used for supplying fuel to fuel cells present in electronic devices.

### BACKGROUND OF THE INVENTION

With the advances made in wireless communication technology, the number of portable electronic devices in the market is increasing day by day. Examples of these portable electronic devices include, but are not limited to, cellular phones, laptops, pagers, portable radios, remote controls, portable audio and/or video players, portable gaming devices, and Personal Data Assistants (PDAs). These portable electronic devices require power to operate. For example, a printer requires power to print papers. Devices that can be used as sources of power in these portable electronic devices include, but are not limited to, cells, fuel cells, zinc-carbon batteries, alkaline batteries, lithium batteries and mercury batteries. Fuel cells are electro-chemical energy conversion devices that generate electrical energy by oxidation of fuels such as hydrogen by oxidants such as air. Examples of fuels are hydrocarbon fuels such as methanol, propane, gasoline, and natural gas; and chemical hydrides such as sodium borohydride, which can be directly oxidized or reformed to produce a directly oxidizable fuel such as hydrogen. Examples of the fuel cells include, but are not limited to, proton-exchange membrane fuel cells, phosphoric acid fuel cells, alkaline fuel cells, metal hydride fuel cells and electro-galvanic fuel cells. A fuel cell in an electronic device can be continuously supplied with fuel or oxidant from external sources. As a result, the fuel cell does not need to be replaced by a new fuel cell after the fuel in the fuel cell is consumed.

A fuel cell refilling system includes a fuel cell, a refillable fuel or oxidant cartridge and a refilling device. The refilling device provides fuel to the refillable fuel cartridge, and the refillable fuel cartridge, in turn, supplies fuel to the fuel cell. Each fuel cell is designed to oxidize only a specific type of fuel. For example, the fuel cell may be compatible with a specific type of fuel. Therefore, when a fuel cell is supplied with a wrong type of fuel or with fuel that has impurities, the fuel cell may get damaged. Nowadays, fake refillable fuel cartridges are manufactured that can be mechanically coupled to a fuel cell. However, these cartridges can contain a low-quality fuel. Therefore, it is necessary to validate a refillable fuel cartridge before it is used to supply fuel to the fuel cell. The refilling device that provides fuel to the refillable fuel cartridge may contain the wrong type of fuel. Additionally, the refilling device may not be compatible with the fuel cell due to business or security reasons. Hence, it becomes necessary for the fuel cell to determine whether an authorized refilling device has refilled the refillable fuel cartridge.

One of the known methods and systems uses a fuel-supply device for refilling a fuel cell in an electronic device. The electronic device provides the fuel-supply device with an identifier that determines the electronic device and the type of fuel to be supplied to the electronic device. Based on this identifier, a third-party authenticator decides whether the electronic device has access rights to the fuel-supply device.

Another known system provides a fuel-storage device that is capable of storing and transferring fuel to an electronic device. Examples of the fuel include, but are not limited to, fuels such as methanol, propane and gasoline. A reformer is used to extract hydrogen from the fuel. The extracted hydrogen is supplied to a fuel cell in the electronic device. The fuel-storage device includes a re-writable memory that stores information relevant to the usage of the fuel-source storage device. A controller, present in the electronic device, can access and change the information stored in the re-writable memory. The changed information determines the subsequent use of the fuel-storage device.

Yet another known system provides a consumable goods-holding unit that supplies consumable goods to a device using consumable goods. Examples of such consumable goods include fuels, inks, toners, and the like. The consumable goods-holding unit includes a consumable-goods management tag that is used to store and update a set of data. The set of data determines the remaining quantity of consumable goods in the consumable goods-holding unit. The device using consumable goods can access and update the set of data stored in the consumable-goods management tag, but stops accepting the consumable goods from the consumable goods-holding unit when the magnitude of the set of data is lower than a pre-defined level.

However, the systems described above have one or more of the following limitations. In one of these systems, the fuel cell in the electronic device does not validate the fuel-supply device before the fuel-supply device is used to supply the fuel to the fuel cell. Moreover, a third system component is required to decide whether the electronic device has access rights to the fuel-supply device. In another system, the electronic device containing the fuel cell is not validated by the fuel-storage device. As a result, a fuel-storage device can supply fuel to an unauthorized electronic device. Additionally, the fuel-storage device is not validated by the electronic device.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 is a block diagram illustrating an exemplary electronic device where various embodiments of the present invention can be practiced;

FIG. 2 is a block diagram illustrating a consuming device, in accordance with an embodiment of the present invention;

FIG. 3 is a block diagram illustrating the communication between a first device and a second device, in accordance with an embodiment of the present invention;

FIG. 4 is a flow diagram illustrating a method for validating a first device by a second device, in accordance with an embodiment of the present invention;

FIGS. 5, 6, 7, 8 and 9 are flow diagrams illustrating a method for validating a refillable fuel cartridge by a refilling device, in accordance with an embodiment of the present invention; and

FIGS. 10, 11, 12, 13 and 14 are flow diagrams illustrating a method for a refillable fuel cartridge being validated by a consuming device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular system for validating refillable fuel cartridges, in accordance with the present invention, it should be observed that the present invention resides primarily in apparatus components related to the system for validating refillable fuel cartridges. Accordingly, the apparatus components have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as first and second, and the like, may be used solely to distinguish one entity or action from another entity or action, without necessarily requiring or implying any actual such relationship or order between such entities or actions. The terms ‘comprises,’ ‘comprising,’ ‘includes,’ ‘including,’ or any other variation thereof, are intended to cover a non-exclusive inclusion, such that a process, article, system or apparatus that comprises a list of elements does not include only those elements but may include other elements not expressly listed or inherent to such a process, article or apparatus. An element preceded by ‘comprises . . . a’ does not, without more constraints, preclude the existence of additional identical elements in the process, article, system or apparatus that comprises the element. The terms ‘includes’ and/or ‘having’, as used herein, are defined as comprising.

The present invention provides a first device that includes a first access controller, a first transceiver and a first fuel container. The first device is a refillable fuel cartridge that can be used with an electronic device. The first access controller is configured to authenticate another device by using a first pre-specified authentication technique. The first transceiver is operatively coupled to the first access controller. The first transceiver is configured to receive an authentication query from the other device. The authentication query is used to authenticate the first device by using a second pre-specified authentication technique. The first fuel container has a compartment that is used to store fuel.

The present invention provides a second device that includes a second access controller, a second transceiver and a second fuel container. The second access controller is configured to authenticate a refillable fuel cartridge by using a second pre-specified authentication technique. The second transceiver is operatively coupled to the second access controller. The second transceiver is configured to receive an authentication query from the refillable fuel cartridge. The authentication query is used to authenticate the second device by using a first pre-specified authentication technique. The second fuel container is operatively coupled to the second access controller. The second fuel container has a compartment that is used to store fuel.

The present invention provides a system that includes a first device and a second device. The first device is a refillable fuel cartridge that can be used with an electronic device. The first device includes a first access controller, a first transceiver and a first fuel container. The first access controller authenticates the second device by using a first pre-specified authentication technique. The first transceiver is operatively coupled to the first access controller. The first transceiver is configured to receive an authentication query from the second device. The first fuel container has a first compartment that is used to store fuel. The second device includes a second access controller, a second transceiver and a second fuel container. The second transceiver and the second fuel container are operatively coupled to the second access controller. The second access controller is configured to authenticate the first device by using a second pre-specified authentication technique. The second transceiver is configured to receive an authentication query from the first device. The second fuel container has a second compartment that is used to store fuel.

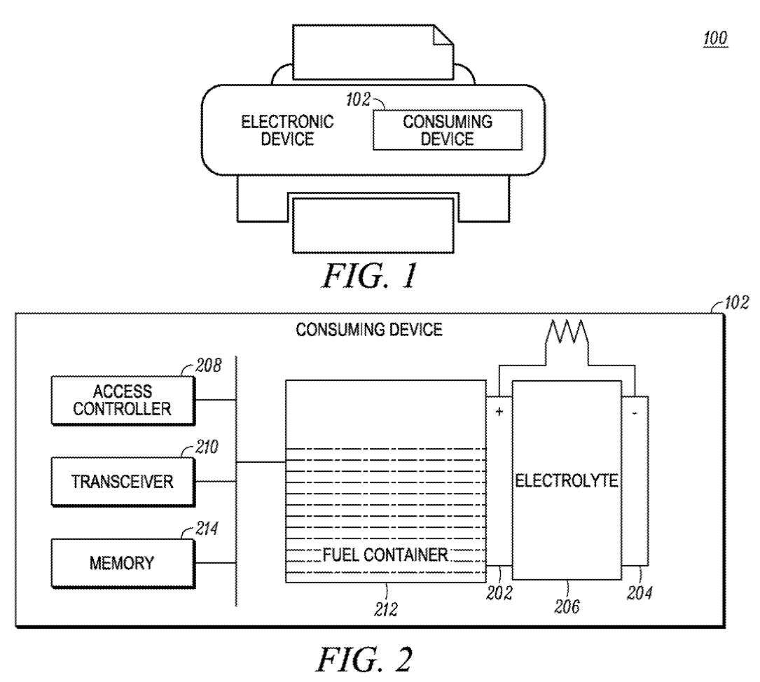

Referring to FIG. 1, there is shown a block diagram illustrating an exemplary electronic device 100, where various embodiments of the present invention can be practiced. Examples of the electronic device 100 include, but are not limited to, a cellular phone, a laptop, a printer, a pager, a portable radio, a remote control, a portable audio and/or video player, a portable gaming device, and a Personal Data Assistant (PDA). The electronic device 100 requires power to operate. The electronic device 100 includes a consuming device 102. The consuming device 102 can oxidize fuel to generate electrical energy, which provides power to the electronic device 100. Examples of the consuming device 102 include, but are not limited to, a proton-exchange membrane fuel cell, a phosphoric acid fuel cell, a metal hydride fuel cell, and an electro-galvanic fuel cell. Examples of the fuel include, but are not limited to, hydrogen, natural gas, propane, methanol, formic acid and sodium borohydride. These fuels can be in a liquid, solid or gaseous state. The consuming device 102 can be provided with the fuel from an external supply.

In an embodiment, a refillable fuel cartridge is the external supply of fuel. The refillable fuel cartridge can supply fuel to the consuming device 102, which is designed to oxidize only a specific type of fuel. Therefore, when the consuming device 102 is provided with the wrong type of fuel or with fuel that has impurities, the consuming device 102 can get damaged. To maintain the quality of the fuel being used in the consuming device 102, and to ensure that the consuming device 102 is supplied with the right type of fuel, it is necessary to validate the refillable fuel cartridge before the refillable fuel cartridge is used. A refilling device can provide fuel to the refillable fuel cartridge. However, the refilling device may contain low quality fuel. Moreover, the fuel supplied by the refilling device may not be compatible with the consuming device 102. For example, a manufacturer ‘A’ manufactures a printer with the consuming device 102, and another manufacturer ‘B’ manufactures a refilling device. The manufacturer ‘A’, in this case, may not authorize a refillable fuel cartridge that has been supplied with the fuel by the refilling device manufactured by the manufacturer ‘B’, to supply fuel to the consuming device 102, due to quality or other business reasons. Therefore, it is necessary for the consuming device 102 to determine whether the refillable fuel cartridge has been refilled by an authorized refilling device.

Referring to FIG. 2, there is shown a block diagram illustrating the exemplary consuming device 102, in accordance with an embodiment of the present invention. The consuming device 102 is an electro-chemical device that can oxidize fuel to generate electrical energy. Examples of the consuming device 102 include, but are not limited to, metal-hydride fuel cells, electro-galvanic fuel cells, proton-exchange membrane fuel cells, alkaline fuel cells and phosphoric acid fuel cells. Examples of the fuel include liquid hydrogen, natural gas, propane, methanol, and the like.

In one example, the consuming device 102 is a fuel cell that includes an anode 202, a cathode 204, and a proton-conducting membrane as an electrolyte 206. The anode 202 and the cathode 204 are connected through an external circuit. At the anode 202, hydrogen is dissociated to produce protons and electrons. These protons pass through the electrolyte 206 to reach the cathode 204, and the electrons travel through the external circuit. The flow of the electrons through the external circuit generates electrical energy, which provides power to the electronic device 100. At the cathode 204, oxygen reacts with the protons and the electrons to produce water as a by-product.

The consuming device 102 also includes an access controller 208, a transceiver 210, and a fuel container 212. The transceiver 210 and the fuel container 212 are operatively coupled to the access controller 208. The access controller 208 can authenticate a refillable fuel cartridge by using a pre-specified authentication technique. The refillable fuel cartridge supplies fuel to the consuming device 102. Examples of the pre-specified authentication technique include, but are not limited to, the challenge-response authentication technique. The access controller 208 generates a random challenge that is to be sent to the refillable fuel cartridge. The random challenge is a randomly generated string that can be made of alphanumeric and special characters. The access controller 208 also computes a response signal, based on this random challenge.

The transceiver 210 can receive an authentication query from the refillable fuel cartridge. The authentication query is used to authenticate the consuming device 102 by using the pre-specified authentication technique. The authentication query is a random challenge generated by the refillable fuel cartridge.

In an embodiment, the challenge-response authentication technique is implemented via a wireless communication link. The wireless communication link between the consuming device 102 and the refillable fuel cartridge is established by using the near-field communication method. The near-field communication method establishes wireless connection between two devices when they are within a distance of 20 centimeters from each other. The consuming device 102 emits radio frequency signals, resulting in an electro-magnetic carrier field around the consuming device 102. The refillable fuel cartridge can modulate the existing electro-magnetic carrier field, to respond to an authentication query from the consuming device 102 and to authenticate the consuming device 102.

The fuel container 212 can store fuel in the consuming device 102. This fuel can be oxidized to generate electrical energy. The fuel container 212 enables transfer of fuel from the refillable fuel cartridge to the fuel container 212. The consuming device 102 also includes a memory 214 that is operatively coupled to the access controller 208. The memory 214 is a re-writable memory that is used for storing a set of parameters, which can be accessed by the access controller 208.

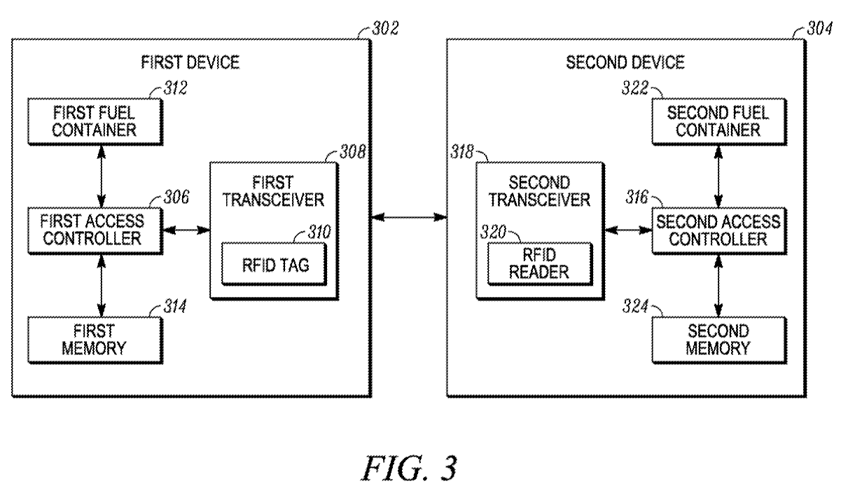

Referring to FIG. 3, there is shown a block diagram illustrating communication between a first device 302 and a second device 304. In an embodiment, the first device 302 and the second device 304 are present with the electronic device 100. The first device 302 is a refillable fuel cartridge that can be used with the electronic device 100. The first device 302 can be used for supplying fuel to the second device 304.

The first device 302 includes a first access controller 306, a first transceiver 308, and a first fuel container 312. The first access controller 306 authenticates the second device 304 by using a first pre-specified authenticating technique. An example of the first pre-specified authentication technique is a challenge-response authentication technique. The first access controller 306 generates a random challenge that is sent to the second device 304. Based on the random challenge, the first access controller 306 computes a response signal. On receiving the random challenge, the second device 304 computes a response signal that is transmitted to the first device 302, which receives the response signal. The received response signal is compared with the computed response signal by the first access controller 306. The second device 304 is determined as authentic by the first device 302 when the computed response signal is the same as the received response signal. In an embodiment, the response signal is computed by using a Standard Hash Algorithm-1 (SHA-1), which is a cryptographic hash function.

The first access controller 306 can also update a status variable of the first device 302 during authentication. The first access controller 306 can also update a status variable of the first device 302 after the fuel has been transferred between the first device 302 and the second device 304. The status variable of the first device 302 can be a single bit, a counter or a fuel gauge. The single bit may be used for the first device 302 that can be used only once. The counter may determine the number of times the first device 302 has been refilled by the second device 304, the number of times the first device 302 has been used to supply fuel to the second device 304, or the number of times the first device 302 has been reconnected to the second device 304. The fuel gauge may indicate the amount of fuel in the first device 302. The status variable of the first device 302 can also be an indicator or a Boolean variable. The Boolean variable may indicate whether the first device 302 has been used to supply fuel to the second device 304 a fixed maximum number of times. The indicator may determine one of the types of fuel in the first device 302, and whether a filter in the first device 302 needs to be replaced.

The first transceiver 308 is operatively coupled to the first access controller 306 and can receive an authentication query from the second device 304. This authentication query can be used to authenticate the first device 302 by using a second pre-specified authentication technique. An example of the second pre-specified authentication technique includes, but is not limited to, a challenge-response authentication technique. The authentication query is a random challenge generated by the second device 304. The first transceiver 308 can send the status variable of the first device 302 to the second device 304 and can also receive a request to update the status variable of the first device 302. This request is sent to the first device 302 by the second device 304. Since the first transceiver 308 on the first device 302 may be a passive tag which gets its power from the electro-magnetic carrier field around the second device 304, it may only operate during transceiver communication.

In an embodiment, the challenge-response authentication technique is implemented via a wireless radio communication link. The near-field communication method is used to establish the wireless radio communication channel between the first device 302 and the second device 304. The first transceiver 308 includes a Radio Frequency Identification (RFID) tag 310 that can be a passive device. The second device 304 initiates the process of establishing the wireless radio communication channel with the first device 302 by emitting radio frequency signals. This results in the formation of an electromagnetic carrier field around the second device 304. The RFID tag 310 may be powered by the electromagnetic field, and modulates the electromagnetic carrier field, to respond to the second device 304.

The first fuel container 312 can store fuel, which can be oxidized to generate electrical energy. The first fuel container 312 enables the transfer of the fuel between the first device 302 and the second device 304. The first device 302 also includes a first memory 314. The first memory 314 is a rewritable memory that can be accessed by the first access controller 306. The first memory 314 can store the status variable of the first device 302. The first memory 314 can also store the random challenge sent by the second device 304 and the response signal computed by the first device 302.

The second device 304 includes a second access controller 316, a second transceiver 318, and a second fuel container 322. The second access controller 316 authenticates the first device 302 by using the second pre-specified authentication technique. The second access controller 316 generates a random challenge that is sent to the first device 302. The second access controller 316 can compute a response signal, based on the random challenge. On receiving the random challenge, the first device 302 computes a response signal that is sent to the second device 304, which receives the response signal. The second access controller 316 compares the received response signal with the computed response signal. The first device 302 is determined as authentic by the second device 304 when the computed response signal is the same as the received response signal. The response signal can be computed by using SHA-1.

The second access controller 316 can also check the status variable of the first device 302. The status variable of the first device 302 may indicate whether the first device 302 has been refilled by an authentic refilling device. Checking the status variable of the first device 302 includes comparing the status variable of the first device 302 with some of the parameters from a set of parameters stored in the second device 304. The second access controller 316 may enable transfer of fuel between the second fuel container 322 and the first device 302 when the status variable of the first device 302 is a valid value. The second access controller 316 may disable the transfer of fuel between the second fuel container 322 and the first device 302 when the status variable of the first device 302 is an invalid value. The second access controller 316 may also discard the first device 302 when the status variable of the first device 302 is an invalid value.

The second access controller 316 is operatively coupled to the second transceiver 318, which can receive an authentication query from the first device 302. The authentication query is used to authenticate the second device 304 by using the first pre-specified authentication technique. The second transceiver 318 can also receive the status variable of the first device 302. The second transceiver 318 can also send a request to the first device 302, to update the status variable of the first device 302. In an embodiment, the second transceiver 318 includes a Radio Frequency Identification (RFID) reader 320. The RFID reader 320 is an active device that initiates the process of establishing the wireless radio communication channel with the first device 302 by emitting radio frequency signals, resulting in the formation of an electro-magnetic carrier field around the second device 304. The RFID tag 310 modulates the existing electromagnetic carrier field to respond to the RFID reader 320. The second fuel container 322 can store fuel, which can be oxidized to generate electrical energy. The second fuel container 322 may enable the transfer of fuel between the first device 302 and the second device 304.

The second device 304 also includes a second memory 324 that is operatively coupled to the second access controller 316. The second memory 324 is a re-writable memory that can be accessed by the second access controller 316. The second memory 324 can store the set of parameters required for checking the status variable of the first device 302. The set of parameters can include a constant, which determines the maximum number of times the first device 302 can be refilled by the second device 304, the minimum amount of fuel that must always be present in the first device 302, the maximum number of times the first device 302 can be reconnected to the second device 304 without fuel leakage, or the maximum number of times the first device 302 can be used to supply fuel to the second device 304. The set of parameters may also include an indicator that determines the type of fuel the second device 304 can oxidize, and the like. The second memory 324 may also store the status variable of the first device 302, communicated from the first device 302 to the second device 304 at the time of authentication, or after fuel transfer has been detected at the second fuel container 322.

In an embodiment, the second device 304 is a refilling device and can be present, external to the electronic device 100. The first device 302 can be inserted into the second device 304. The second access controller 316 can enable transfer of fuel from the second fuel container 322 to the first fuel container 312 when the status variable of the first device 302 is a valid value. The second access controller 316 disables the transfer of fuel from the second fuel container 322 to the first fuel container 312 when the status variable of the first device 302 is an invalid value. The second access controller 316 can also discard the first device 302 when the status variable of the first device 302 is an invalid value. The second fuel container 322 can transfer fuel from the second fuel container 322 to the first fuel container 312.

In another embodiment, the second device 304 is a consuming device present in the electronic device 100. The first device 302 can be inserted into the electronic device 100. The second access controller 316 enables transfer of fuel from the first fuel container 312 to the second fuel container 322 when the status variable of the first device 302 is a valid value. The second access controller 316 can also disable the transfer of fuel from the first fuel container 312 to the second fuel container 322 when the status variable of the first device 302 is an invalid value. The second access controller 316 discards the first device 302 when the status variable of the first device 302 is an invalid value. The second fuel container 322 can transfer fuel from the first fuel container 312 to the second fuel container 322.

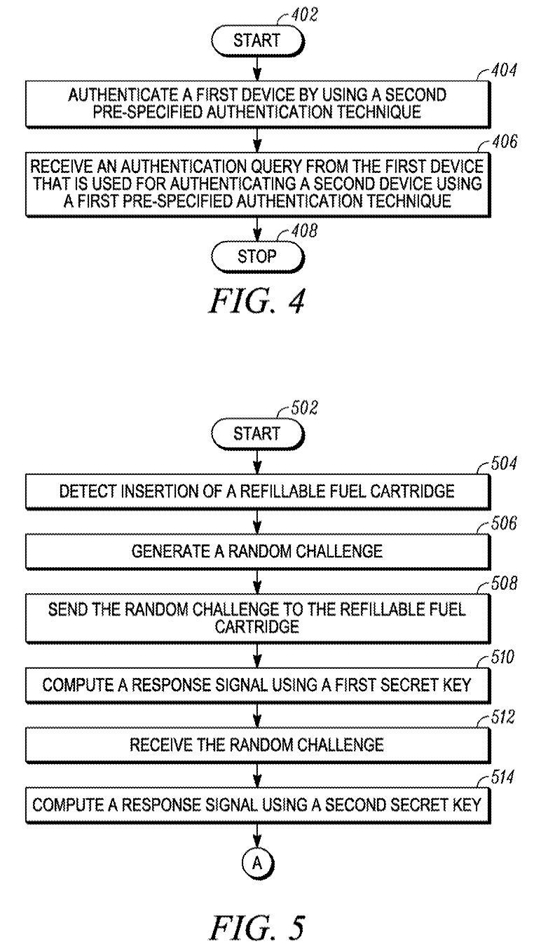

Referring to FIG. 4, there is shown a flow diagram illustrating a method for validating the first device 302, in accordance with an embodiment of the present invention. To describe the method, reference will be made to FIGS. 1, 2 and 3. However, it will be apparent to a person ordinarily skilled in the art that the method can be implemented with reference to any other suitable embodiment of the present invention.

At step 402, the method for validating the first device 302 is initiated. The first device 302 is a refillable fuel cartridge that can be used in the electronic device 100. At step 404, the first device 302 is authenticated by the second device 304. The second device 304 authenticates the first device 302 by using a second pre-specified authentication technique. An example of the second pre-specified authentication technique is the challenge-response authentication technique. The second device 304 can be a refilling device or a consuming device.

At step 406, the second device 304 receives an authentication query from the first device 302. The authentication query is used to authenticate the second device 304 by using the first pre-specified authentication technique. An example of the first pre-specified authentication technique is a challenge-response authentication technique. The first device 302 authenticates the second device 304, based on the first pre-specified authentication technique. At step 408, the method is terminated.

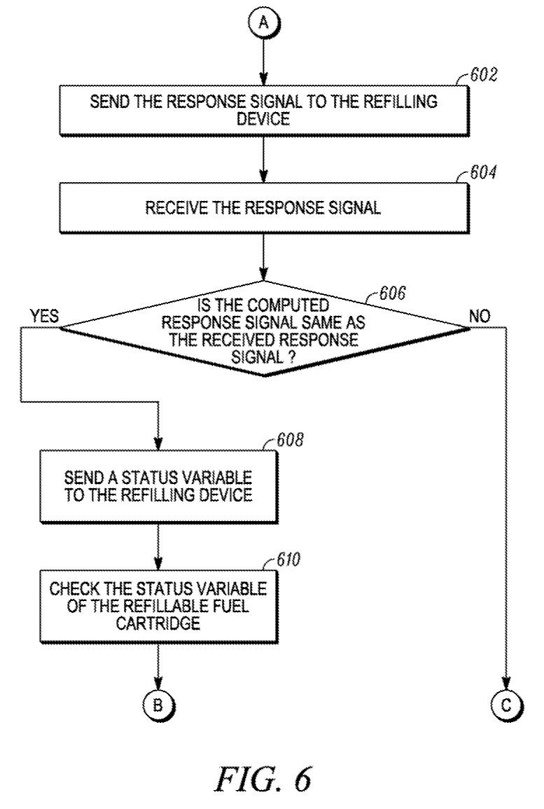

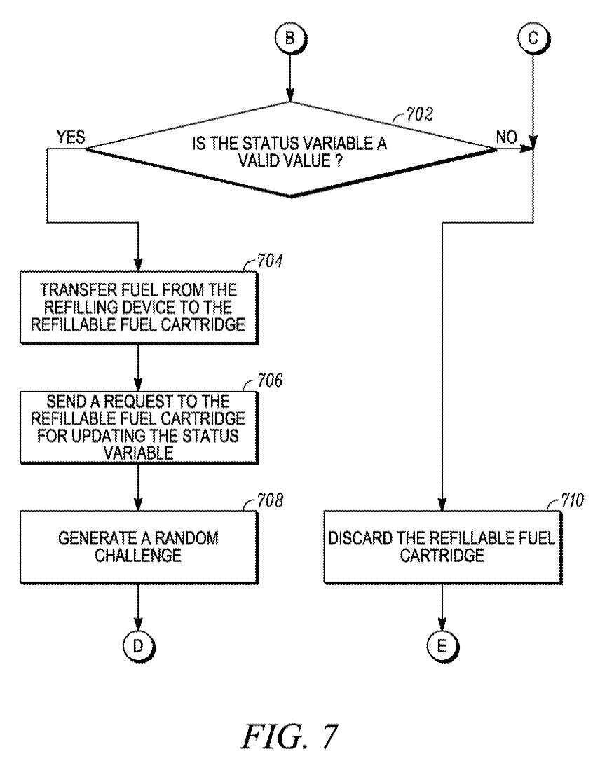

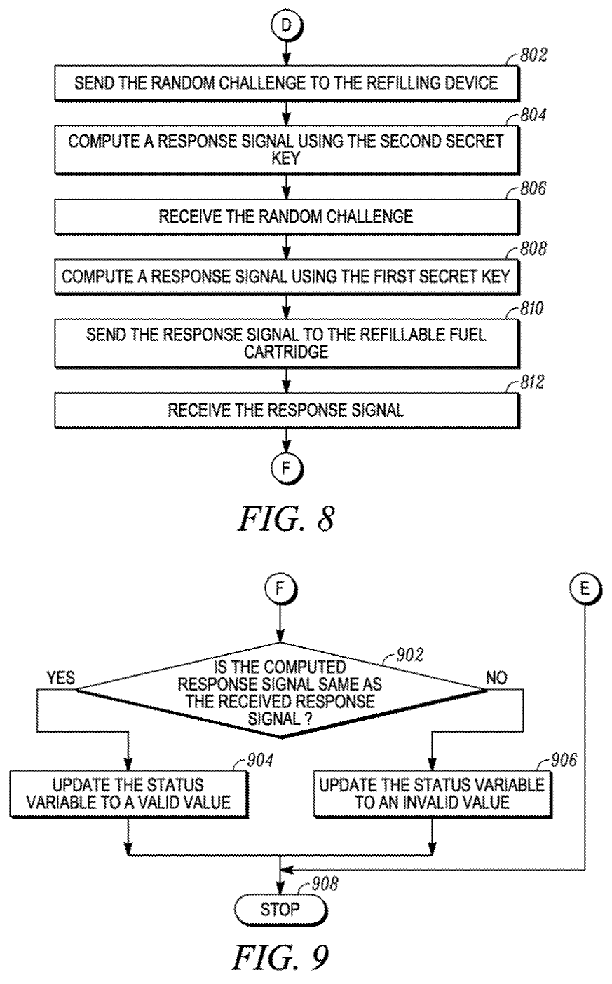

Referring to FIGS. 5, 6, 7, 8 and 9, there are shown flow diagrams illustrating a method for validating a refillable fuel cartridge by a refilling device, in accordance with an embodiment of the present invention. To describe the method, reference will be made to FIGS. 1, 2 and 3, although it should be understood that the method can be implemented in any other suitable embodiment of the present invention. Further, the method can have a greater or fewer numbers of steps than shown in FIGS. 5, 6, 7, 8 and 9.

At step 502, the method for validating the first device 302, hereinafter referred to as the refillable fuel cartridge 302, is initiated. The refillable fuel cartridge 302 is validated by the second device 304, hereinafter referred to as the refilling device 304. At step 504, the refilling device 304 detects the insertion of the refillable fuel cartridge 302. The refillable fuel cartridge 302 and the refilling device 304 are connected through a wired communication link. The wired communication link can be a one-wire bus that communicably connects the refillable fuel cartridge 302 and the refilling device 304. The one-wire bus is a serial bus that connects two devices, allows one of these two devices to be powered by the other device, and enables bi-directional flow of data between these two devices.

In an embodiment, the refilling device 304 detects the insertion of the refillable fuel cartridge 302 through a wireless radio communication channel. In an embodiment, the wireless radio communication channel is established by using the near-field communication method. An electronic circuit on the RFID tag 310 of the refillable fuel cartridge 302 can be a passive circuit that does not have any internal power supply. The RFID reader 320 in the refilling device 304 emits radio frequency signals, resulting in an electro-magnetic carrier field around the refilling device 304. These radio frequency signals are received by the RFID tag 310 of the first transceiver 308 on the refillable fuel cartridge 302. The RFID tag 310, on receiving these radiofrequency signals, demodulates and rectifies the radio frequency signals to power the electronic circuit on the RFID tag 310. The RFID tag 310 modulates the electromagnetic carrier field, to respond to the RFID reader 320 when the refillable fuel cartridge 302 is inserted into the refilling device 304. The RFID reader 320 and the RFID tag 310 are communicably coupled through the wireless radio communication channel.

At step 506, the refilling device 304 generates a random challenge that is sent to the refillable fuel cartridge 302. In an embodiment, the random challenge is a wireless random challenge that can be transmitted over the wireless radio communication channel connecting the refillable fuel cartridge 302 and the refilling device 304. At step 508, the refilling device 304 sends the random challenge to the refillable fuel cartridge 302. At step 510, the refilling device 304 computes a response signal corresponding to the random challenge by using a first secret key. The refilling device 304 computes the response signal by performing cryptographic functions on the random challenge. In an embodiment, SHA-1 is implemented to encrypt the random challenge, based on the first secret key, to generate the response signal. The SHA-1 is a cryptographic hash function that can perform logical operations such as ADD, XOR, AND, OR and ROTATE on the random challenge. At step 512, the refillable fuel cartridge 302 receives the random challenge.

At step 514, the refillable fuel cartridge 302 computes a response signal corresponding to the received random challenge, based on a second secret key. The refillable fuel cartridge 302 performs cryptographic functions on the received random challenge, to generate the response signal. In an embodiment, SHA-1 is implemented to encrypt the received random challenge, based on the second secret key, to generate the response signal.

At step 602, the refillable fuel cartridge 302 sends the response signal to the refilling device 304. At step 604, the refilling device 304 receives the response signal sent by the refillable fuel cartridge 302. At step 606, the refilling device 304 compares the computed response signal with the response signal received from the refillable fuel cartridge 302. In an embodiment, the second access controller 316 compares the computed response signal with the response signal received from the refillable fuel cartridge 302.

If it is determined at step 606 that the computed response signal is the same as the response signal received from the refillable fuel cartridge 302, the refillable fuel cartridge 302 transmits the status variable of the refillable fuel cartridge 302 to the refilling device 304 at step 608. The status variable of the refillable fuel cartridge 302 is stored in the first memory 314. At step 610, the refilling device 304 checks the status variable of the refillable fuel cartridge 302. The process of checking the status variable of the refillable fuel cartridge 302 includes comparing the status variable of the refillable fuel cartridge 302 with the set of parameters stored in the second memory 324.

At step 702, the refilling device 304 determines whether the status variable of the refillable fuel cartridge 302 is valid. In an embodiment, the status variable of the refillable fuel cartridge 302 is a valid value when the refillable fuel cartridge 302 is an approved model, manufactured by an approved manufacturer, or filled by an approved refilling device. In an embodiment, the status variable of the refillable fuel cartridge 302 is a valid value when the value of the counter that determines the number of times the refillable fuel cartridge 302 has been refilled by the refilling device 304 is less than the constant that determines the maximum number of times the refillable fuel cartridge 302 can be refilled by the refilling device 304. In an embodiment, the status variable of the refillable fuel cartridge 302 is a valid value when the amount of fuel present in the refillable fuel cartridge 302, as indicated by the fuel gauge, is more than the constant that determines the minimum amount of fuel that must always be present in the refillable fuel cartridge 302.

If it is determined at step 702 that the status variable of the refillable fuel cartridge 302 is a valid value, fuel is transferred from the refilling device 304 to the refillable fuel cartridge 302 at step 704. At step 706, the refilling device 304 sends a request to the refillable fuel cartridge 302, to update the status variable of the refillable fuel cartridge 302. At step 708, the refillable fuel cartridge 302 generates a random challenge that is sent to the refilling device 304. In another embodiment, the random challenge is a wireless random challenge that can be transmitted over the wireless radio communication channel connecting the refillable fuel cartridge 302 and the refilling device 304.

If it is determined at step 606 that the computed response signal is different from the response signal received from the refillable fuel cartridge 302, the refilling device 304 discards the refillable fuel cartridge 302 at step 710. The refillable fuel cartridge 302 is discarded by disabling transfer of fuel from the refilling device 304 to the refillable fuel cartridge 302. If it is determined at step 702 that the status variable of the refillable fuel cartridge 302 is an invalid value, the refilling device 304 disables the transfer fuel from the refilling device 304 to the refillable fuel cartridge 302 at step 710.

At step 802, the refillable fuel cartridge 302 sends the random challenge to the refilling device 304. At step 804, the refillable fuel cartridge 302 computes a response signal corresponding to the random challenge by using the second secret key. The refillable fuel cartridge 302 computes the response signal by performing cryptographic functions on the random challenge. The random challenge is encrypted by using the second secret key. At step 806, the refilling device 304 receives the random challenge. At step 808, the refilling device 304 computes a response signal corresponding to the received random challenge, based on the first secret key. The refilling device 304 performs cryptographic functions on the received random challenge, to generate the response signal. At step 810, the refilling device 304 sends the response signal to the refillable fuel cartridge 302. At step 812, the refillable fuel cartridge 302 receives the response signal sent by the refilling device 304.

At step 902, the refillable fuel cartridge 302 compares the computed response signal with the response signal received from the refilling device 304. If it is determined at step 902 that the computed response signal is the same as the response signal received from the refilling device 304, the refillable fuel cartridge 302 updates the status variable of the refillable fuel cartridge 302 to a valid value at step 904. If it is determined at step 902 that the computed response signal is different than the response signal received from the refilling device 304, the refillable fuel cartridge 302 updates the status variable of the refillable fuel cartridge 302 to an invalid value at step 906. At step 908, the method is terminated.

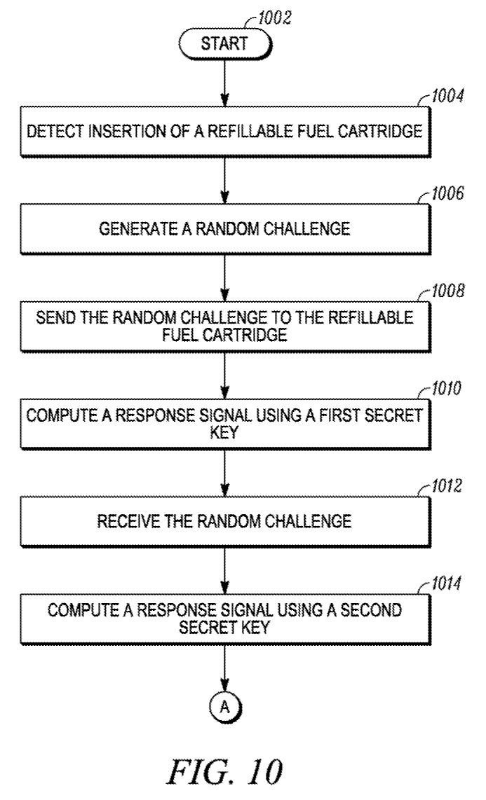

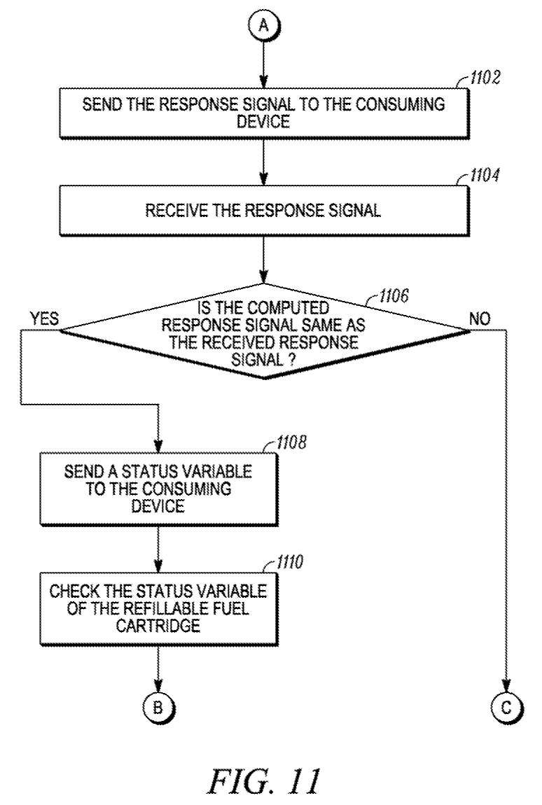

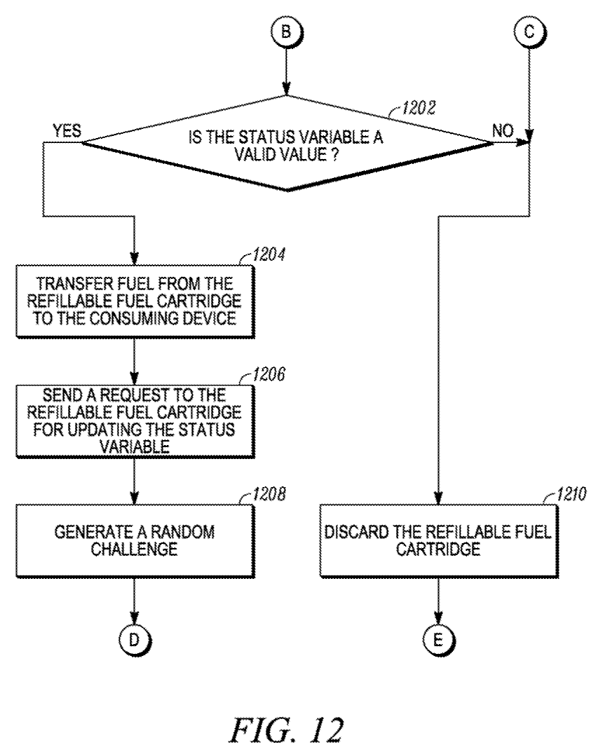

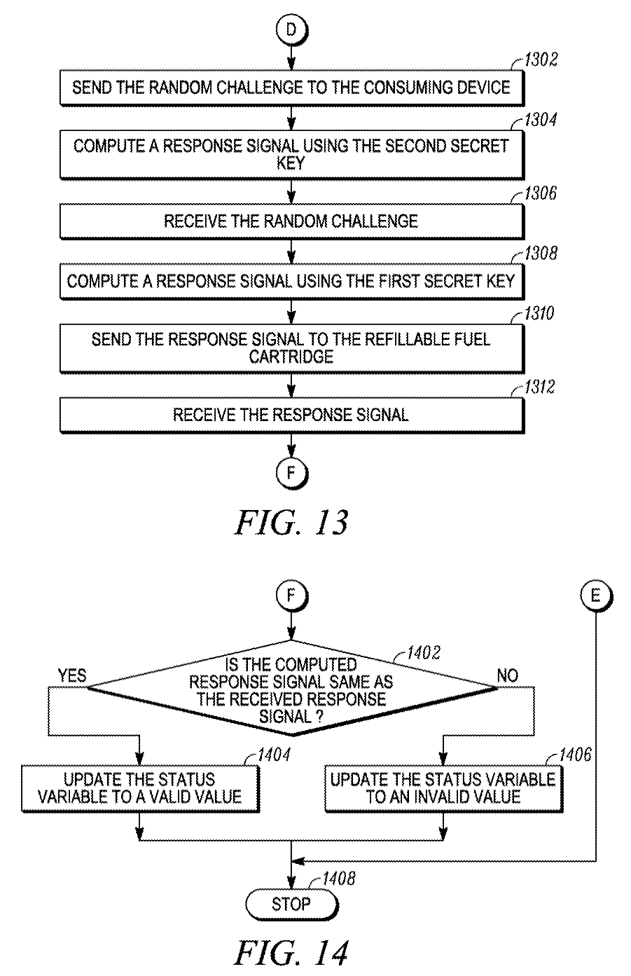

Referring to FIGS. 10, 11, 12, 13 and 14, there are shown flow diagrams illustrating a method for validating a refillable fuel cartridge by a consuming device, in accordance with an embodiment of the present invention. To describe the method, reference will be made to FIGS. 1, 2 and 3, although it is understood that the method can be implemented in any other suitable embodiment of the present invention. Further, the method can have a greater or fewer numbers of steps than shown in FIGS. 10, 11, 12, 13 and 14.

At step 1002, the method for validating the first device 302, hereinafter referred to as the refillable fuel cartridge 302, is initiated. The refillable fuel cartridge 302 is validated by the second device 304, hereinafter referred to as the consuming device 304. At step 1004, the consuming device 304 detects the insertion of the refillable fuel cartridge 302. The refillable fuel cartridge 302 and the consuming device 304 are connected through a wired communication link when the refillable fuel cartridge 302 is inserted into the electronic device 100. The wired communication link can be a one-wire bus that communicably connects the refillable fuel cartridge 302 and the consuming device 304. The one-wire bus is a serial bus that connects two devices, allows one of these two devices to be powered by the other device, and enables bi-directional flow of data between these two devices.

In an embodiment of the present invention, the consuming device 304 detects the insertion of the refillable fuel cartridge 302 through a wireless radio communication channel. In an embodiment, the wireless radio communication channel is established by using a near-field communication method. At step 1006, the consuming device 304 generates a random challenge that is sent to the refillable fuel cartridge 302. In an embodiment, the random challenge is a randomly generated string made of alphanumeric and special characters. In another embodiment, the random challenge is a wireless random challenge that can be transmitted over the wireless radio communication channel connecting the refillable fuel cartridge 302 and the consuming device 304.

At step 1008, the consuming device 304 sends the random challenge to the refillable fuel cartridge 302. At step 1010, the consuming device 304 computes a response signal corresponding to the random challenge by using a first secret key. The random challenge is encrypted by using the first secret key. At step 1012, the refillable fuel cartridge 302 receives the random challenge. At step 1014, the refillable fuel cartridge 302 computes a response signal corresponding to the received random challenge, based on a second secret key. In an embodiment, SHA-1 is implemented to encrypt the received random challenge, based on the second secret key, to generate the response signal.

At step 1102, the refillable fuel cartridge 302 sends the response signal to the consuming device 304. At step 1104, the consuming device 304 receives the response signal sent by the refillable fuel cartridge 302. At step 1106, the consuming device 304 compares the computed response signal with the response signal received from the refillable fuel cartridge 302. At step 1108, the refillable fuel cartridge 302 transmits the status variable of the refillable fuel cartridge 302 to the consuming device 304 when the computed response signal is the same as the response signal received from the refillable fuel cartridge 302. In an embodiment, the first transceiver 308 sends the status variable of the refillable fuel cartridge 302 to the consuming device 304. At step 1110, the consuming device 304 checks the status variable of the refillable fuel cartridge 302.

At step 1202, the consuming device 304 determines whether the status variable of the refillable fuel cartridge 302 is a valid value. In an embodiment, the status variable of the refillable fuel cartridge 302 is a valid value when the refillable fuel cartridge 302 is an approved model or manufactured by an approved manufacturer, or has been filled by an approved refilling device. In an embodiment, the status variable of the refillable fuel cartridge 302 is a valid value when the value of the counter that determines the number of times the refillable fuel cartridge 302 has been used to supply fuel to the consuming device 304 is less than the constant that determines the maximum number of times the refillable fuel cartridge 302 can be used to supply fuel to the consuming device 304. In an embodiment, the status variable of the refillable fuel cartridge 302 is a valid value when the amount of fuel present in the refillable fuel cartridge 302, as indicated by the fuel gauge, is more than the constant that determines the minimum amount of fuel that must always be present in the refillable fuel cartridge 302.

At step 1204, fuel is transferred from the refillable fuel cartridge 302 to the consuming device 304 when the status variable of the refillable fuel cartridge 302 is a valid value. At step 1206, the consuming device 304 sends a request to the refillable fuel cartridge 302 to update the status variable of the refillable fuel cartridge 302. At step 1208, the refillable fuel cartridge 302 generates a random challenge that is sent to the consuming device 304. At step 1210, the consuming device 304 discards the refillable fuel cartridge 302 when the computed response signal is different than the response signal received from the refillable fuel cartridge 302.

At step 1302, the refillable fuel cartridge 302 sends the random challenge to the consuming device 304. At step 1304, the refillable fuel cartridge 302 computes a response signal corresponding to the random challenge by using the second secret key. The random challenge is encrypted by using the second secret key. At step 1306, the consuming device 304 receives the random challenge sent by the refillable fuel cartridge 302. At step 1308, the consuming device 304 computes a response signal corresponding to the received random challenge, based on the first secret key. In an embodiment, SHA-1 is implemented to encrypt the received random challenge, based on the first secret key, to generate the response signal. At step 1310, the consuming device 304 sends the response signal to the refillable fuel cartridge 302. At step 1312, the refillable fuel cartridge 302 receives the response signal sent by the consuming device 304.

At step 1402, the refillable fuel cartridge 302 compares the computed response signal with the response signal received from the consuming device 304. At step 1404, the refillable fuel cartridge 302 updates the status variable of the refillable fuel cartridge 302 to a valid value when the computed response signal is the same as the response signal received from the consuming device 304. At step 1406, the refillable fuel cartridge 302 updates the status variable of the refillable fuel cartridge 302 to an invalid value when the computed response signal is different from the response signal received from the consuming device 304. At step 1408, the method is terminated.

As discussed above, various embodiments of the present invention provide a system for validating refillable fuel cartridges. The present invention enables two-way authentication between a refillable fuel cartridge and a refilling device. The present invention also enables two-way authentication between the refillable fuel cartridge and a consuming device in an electronic device. As a result, a refillable fuel cartridge with the wrong type of fuel or with fuel that has impurities is not allowed to supply fuel to the consuming device. Moreover, the present invention helps to prevent the use of fake refillable fuel cartridges in such electronic devices. The present invention also provides two-way wireless authentication of the refilling device, the refillable fuel cartridge and the consuming device.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of those claims, as issued.

What is claimed is:

1. A refillable fuel cartridge for an electronic device comprising:
a fuel container having a compartment to store fuel;
an access controller configured to authenticate another device using a first pre-specified authentication technique; and
a transceiver operatively coupled to the access controller, the transceiver being configured to receive an authentication query from the other device, the authentication query being used for authenticating the refillable fuel cartridge using a second pre-specified authentication technique.

2. The refillable fuel cartridge as recited in claim 1, wherein the other device is a refilling device or a consuming device.

3. The refillable fuel cartridge as recited in claim 1, wherein the fuel container is operatively coupled to the access controller and stores fuel that is capable of being oxidized to produce electrical energy.

4. The refillable fuel cartridge as recited in claim 3, wherein the fuel container is configured to authorize transfer of the fuel between the refillable fuel cartridge and the other device.

5. The refillable fuel cartridge as recited in claim 1, further comprising a memory being configured to store a status variable of the refillable fuel cartridge, wherein the access controller is configured to update the status variable of the refillable fuel cartridge to a valid value or an invalid value.

6. The refillable fuel cartridge as recited in claim 1, wherein the transceiver is configured to:
send a status variable of the refillable fuel cartridge to the other device; and
receive a request from the other device for updating the status variable of the refillable fuel cartridge.

7. The refillable fuel cartridge as recited in claim 1, wherein the transceiver comprises a Radio Frequency Identification (RFID) tag.

8. The refillable fuel cartridge as recited in claim 1, wherein each of the first pre-specified authentication technique and second pre-specified authentication technique is a challenge-response authentication technique.

9. An electronic device comprising:
a fuel container having a compartment to store fuel;
an access controller operatively coupled to the fuel container, the access controller being configured to authenticate a refillable fuel cartridge to be used with another device using a second pre-specified authentication technique; and
a transceiver operatively coupled to the access controller, the transceiver being configured to receive an authentication query from the refillable fuel cartridge, the authentication query being used for authenticating the refillable fuel cartridge using a first pre-specified authentication technique.

10. The electronic device as recited in claim 9, wherein the fuel container is configured to store fuel that is capable of being oxidized to produce electrical energy.

11. The electronic device as recited in claim 10, wherein the fuel container is configured to enable transfer of the fuel between the electronic device and the refillable fuel cartridge.

12. The electronic device as recited in claim 11, wherein:
the electronic device is a refilling device; and
the fuel is provided to the refillable fuel cartridge by the electronic device.

13. The electronic device as recited in claim 11, wherein:
the electronic device is a consuming device to be used in the other device; and
the fuel is received by the electronic device from the refillable fuel cartridge.

14. The electronic device as recited in claim 9, wherein the access controller is configured to:
check a status variable of the refillable fuel cartridge;
enable transfer of fuel between the fuel container and the refillable fuel cartridge when the status variable of the refillable fuel cartridge is a valid value; and
disable transfer of fuel between the fuel container and the refillable fuel cartridge when the status variable of the refillable fuel cartridge is an invalid value.

15. The electronic device as recited in claim 14, wherein the access controller is configured to discard the refillable fuel cartridge.

16. The electronic device as recited in claim 19, wherein the transceiver is configured to:
receive a status variable of the refillable fuel cartridge from the refillable fuel cartridge; and
send a request to the refillable fuel cartridge for updating the status variable of the refillable fuel cartridge.

17. The electronic device as recited in claim 9, further comprising a memory being configured to store a set of parameters required for checking a status variable of the refillable fuel cartridge.

18. The electronic device as recited in claim 9, wherein the transceiver comprises a Radio frequency Identification (RFID) reader.

19. The electronic device as recited in claim 9, wherein each of the first and second pre-specified authentication techniques is a challenge-response authentication technique.

20. A system for validating one or more refillable fuel cartridges, the system comprising:
a refillable fuel cartridge to be used with an electronic device comprising:
a first fuel container having a first compartment to store fuel that is capable of being oxidized to produce electrical energy;
a first access controller operatively coupled to the first fuel container, the first access controller being configured to authenticate a second device using a first pre-specified authentication technique; and
a first transceiver operatively coupled to the first access controller, the first transceiver being configured to receive an authentication query from the second device,
wherein the second device comprises:
a second fuel container having a second compartment to store fuel that is capable of being oxidized to produce electrical energy;
a second access controller operatively coupled to the second fuel container, the second access controller being configured to authenticate the first device using a second pre-specified authentication technique; and
a second transceiver operatively coupled to the second access controller, the second transceiver being configured to receive an authentication query from the first device.
